(19) United States
(12) Patent Application Publication
(10) Pub. No.: US 2005/0141240 A1
(43) Pub. Date: Jun. 30, 2005

(54) Light emitting device and fabrication method thereof

(76) Inventors: Masayuki Hata, Osaka (JP); Ryoji Hiroyama, Kyo-tanabe-shi (JP); Tatsuya Kunisato, Osaka (JP); Keiichi Kuramoto, Osaka (JP); Hitoshi Hirano, Nishinomiya-shi (JP)

Correspondence Address: McDERMOTT WILL & EMERY LLP, 600 13th Street, N.W., Washington, DC, 20005-3096, US

(21) Appl. No.: 10/953,066

(22) Filed: Sep. 30, 2004

(30) Foreign Application Priority Data
Sep. 30, 2003 (JP) 2003-338977

(51) Int. Cl. F21V 7/00

(52) U.S. Cl. 362/600

(57) ABSTRACT

A pre-curing viscous solution (precursor solution) is applied to the back surface of a substrate for forming an optically transparent layer principally composed of an inorganic material. The substrate is heated or irradiated with UV light while being pressed with unevenness of a mold. By removing the substrate from the mold, the optically transparent, inorganic material layer principally composed of the inorganic material is formed on the substrate. In this manner, the inorganic material layer with the unevenness is formed on the back surface of the substrate (a light extraction surface) by embossing.

### BACKGROUND OF THE INVENTION

1. Field of the Invention

The present invention relates to a light emitting device having a light emitting device structure and the fabrication method thereof.

2. Description of the Background Art

Light emitting diodes (LEDs) are capable of emitting electromagnetic waves in ultraviolet (UV), visible, or infrared (IR) regions of the electromagnetic spectrum. The LEDs emitting UV light and visible light are used for illumination and displays.

A problem with LEDs is a low light extraction efficiency. Light extraction efficiency is defined as the ratio of the number of photons emitted out of the LED to the number of photons produced in the LED. The low light extraction efficiency is caused by only a fraction of the light energy produced by a light emitting layer (i.e., active layer) emitted out of an LED as light. In the case of an AlGaAs-based LED with a transparent substrate, for example, about 30% of the light energy produced by the light emitting layer is emitted out of the LED.

As a consequence of the low light extraction efficiency, only a fraction of consumed electrical input contributes to externally observable light.

Light emitted by the light emitting layer is reflected off an inner surface of the LED, and absorbed by contact electrodes. The absorptive property of the contact electrodes therefore contribute to the low light extraction efficiency.

Loss mechanisms responsible for the low light extraction efficiency include light absorption within the LED, reflection loss when light passes from one material into another material having a different reflective index, and total reflection that is to be absorbed within the LED.

Critical angle as used herein is defined as
θ_{c}=arc sin (nₛᵤᵣ/n_{LED}),
where nₛᵤᵣ and N_{LED} represent the refractive index of the material surrounding the LED and the refractive index of the LED, respectively.

Total reflection, which occurs when photons produced by the light emitting layer reach the interface between the LED and the surrounding material at an angle greater than the critical angle (θ_{c}), prevents photons from being emitted out of the LED.

The LED is encapsulated in an epoxy resin, for example. The refractive index of the epoxy resin (n_{EPOXY}) is about 1.5. For an LED formed by an III-V semiconductor material, the refractive index ranges from about 2.4 to about 4.1. Taking an average refractive index n_{LED} of LEDs to be about 3.5, a typical value for the critical angle θ_{c} is 25°. Thus, among the photons produced from a point source in the light emitting layer, photons passing through any surface within an escape cone with a half-apex angle of 25° are emitted out of the LED.

Photons incident on the interface between the LED and the outside material of the escape cone is repeatedly subjected to total reflections, and become absorbed by, for example, the semiconductor layers including the light emitting layer or the contact electrodes. In other words, many of the photons incident on a surface at an angle greater than 25° to the axis normal to the surface are not emitted out of the LED at the initial phase. An LED with a higher light extraction efficiency that allows more of the produced photons to be extracted is needed.

For this reason, a technique for improving the light extraction efficiency has been proposed (refer to JP2003-17740 A and JP 6-151972 A).

Described in JP 2003-17740 A is the shaping of one or more surfaces of a semiconductor light emitting device into Fresnel lenses or holographic diffusers. A Fresnel lens allows many of the photons produced from the active layer to be strike the surface of the semiconductor light emitting device at a nearly normal angle of incidence, thereby minimizing the loss of light due to total reflection. In addition, a surface of a semiconductor light emitting device shaped into a pattern such as a Fresnel lens reduces the reflective loss of light that is usually caused by the lens material having a different refractive index from that of the material constituting the semiconductor light emitting device.

Illustrated examples of the methods for forming a Fresnel lens or the like on the surface of a semiconductor light emitting device are, chemical wet etching, dry etching, mechanical machining, and stamping. Stamping entails pressing a stamping block with the desired pattern against the surface of the semiconductor light emitting device. The stamping process is carried out at a temperature above the ductile transition point of the semiconductor material that is to be stamped.

JP 6-151972 A describes a method for fabricating a light emitting device of a lens-on-chip type. In this fabrication method, multiple of microlenses are fabricated on a semiconductor light emitting device substrate as follows: first, a stamper for microlenses is prepared, and a molten resin is injected into the stamper. Then, the stamper having the molten resin injected is positioned on the semiconductor light emitting device substrate, where a lot of semiconductor light emitting device chips of a microregion emission type with a light emission window are formed. After the molten resin has been cured, the stamper is removed.

The method described in JP 2003-17740 A offers a higher light extraction efficiency by processing a semiconductor itself; but on the other hand, easily introduces defects in the substrate due to the damage caused by heating the semiconductor at high temperature for stamping. For a semiconductor light emitting device made of a material having a high ductile transition point, such as a nitride-based semiconductor, heating at very high temperature is required.

The method described in JP 6-151972 A allows heating at low temperature by using a thermoplastic resin; however, for direct formation of microlenses in the light emitting device structure that serves as a heat generation source, it is preferable to use a material having a higher heat resistance.

### SUMMARY OF THE INVENTION

It is an object of the present invention to provide a light emitting device having a sufficiently improved light extraction efficiency without causing defects in the light emitting device structure and the fabrication method thereof.

It is another object of the present invention to provide a method of fabricating a light emitting device which allows the light extraction efficiency to be sufficiently improved without causing defects in the light emitting device structure with reduced manufacturing cost.

A light emitting device according to one aspect of the present invention comprises: a light emitting device structure including a light emitting layer and having a light extraction surface; and a layer principally composed of an inorganic material different from a material constituting the light extraction surface, and formed on the light extraction surface of the light emitting device structure, wherein the layer principally composed of the inorganic material is optically transparent to a luminescent wavelength of the light emitting device structure, and has unevenness on the surface opposite to the light extraction surface, and the layer principally composed of the inorganic material includes a plurality of layers having different refractive indices, the refractive index of a layer on the side of the light extraction surface being greater than the refractive index of another layer.

In the light emitting device, light produced from the light emitting layer of the light emitting device structure is emitted outside through the light extraction surface and the layer principally composed of the inorganic material with the unevenness. In this case, the inorganic material with the unevenness allows Fresnel reflection on the light extraction surface to be reduced. It is also possible for the refractive index of the layer principally composed of the inorganic material to be increased. This results in the sufficiently improved light extraction efficiency.

Moreover, there would be no defects in the light emitting device structure, because the layer principally composed of the inorganic material is formed on the light extraction surface that has not been processed itself. Thus, the degradation of characteristics of the light emitting device structure is prevented.

Further, the thickness of the layer principally composed of the inorganic material can be increased with a further reduction in the Fresnel reflection on the interface between the light extraction surface and the layer principally composed of the inorganic material.

A light emitting device according to another aspect of the present invention comprises: a light emitting device structure including a light emitting layer and having a light extraction surface; and a layer principally composed of an inorganic material different from a material constituting the light extraction surface, and formed on the light extraction surface of the light emitting device structure, wherein the layer principally composed of the inorganic material is optically transparent to a luminescent wavelength of the light emitting device structure, and has unevenness on the surface opposite to the light extraction surface, the light emitting device structure constitutes a light emitting device chip, and the layer principally composed of the inorganic material is formed on the light extraction surface of the light emitting device chip except its outer peripheral region or is smaller in thickness on the outer peripheral region of the light extraction surface of the light emitting device chip than on its remaining region.

In the light emitting device, light produced from the light emitting layer of the light emitting device structure is emitted outside through the light extraction surface and the layer principally composed of the inorganic material with the unevenness. In this case, the inorganic material with the unevenness allows Fresnel reflection on the light extraction surface to be reduced. It is also possible for the refractive index of the layer principally composed of the inorganic material to be increased. This results in the sufficiently improved light extraction efficiency.

Moreover, there would be no defects in the light emitting device structure, because the layer principally composed of the inorganic material is formed on the light extraction surface that has not been processed itself. Thus, the degradation of characteristics of the light emitting device structure is prevented.

Further, the formation of cracks on the layer principally composed of the inorganic material on the light extraction surface is prevented, because the layer principally composed of the inorganic material in the outer peripheral region on the light extraction surface of the light emitting device chip is allowed to easily shrink.

The layer principally composed of the inorganic material may have a refractive index greater than the refractive index of the material constituting the light extraction surface.

In this case, Fresnel reflection on the interface between the light extraction surface and the layer principally composed of the inorganic material can be reduced.

The inorganic material may include a metal oxide. In this case, the refractive index of the layer principally composed of the inorganic material can be easily increased.

The layer principally composed of the inorganic material may include fine particles. The layer principally composed of the inorganic material may also include an organic polymer in which fine particles are dispersed.

In this case, the formation of cracks on the layer principally composed of the inorganic material is prevented.

The fine particles may be composed of a metal oxide. In this case, the refractive index of the layer principally composed of the inorganic material can be easily increased.

The layer principally composed of the inorganic material may include an organometallic polymer having an -M-O-M-bond, where M is a metal and O is an oxygen atom.

In this case, the light extraction surface can be prevented from being damaged.

The organometallic polymer may be synthesized from at least one kind of organometallic compounds having a hydrolytic organic group.

In this case, the layer principally composed of the metal oxide can be easily formed on the light extraction surface by a hydrolysis reaction of the organometallic compound.

The organometallic compound may be a metal alkoxide. In this case, the layer principally composed of the metal oxide can be easily formed on the light extraction surface by hydrolysis and polycondensation reactions of the metal alkoxide.

The organometallic compound may have functional groups directly or indirectly bonding to a metal atom, at least one of which can be cured by being subjected to externally supplied energy to be bridged.

In this case, a functional group of the organometallic compound is cured by the externally supplied energy, so that the layer principally composed of the metal oxide can be easily formed on the light extraction surface.

The externally supplied energy may be one of or both of energy by heating and energy by irradiation of light. In this case, the organometallic compound can be easily cured by heating or irradiation of light. This allows the layer principally composed of the metal oxide to be easily formed on the light extraction surface.

The organometallic compound may include at least one or more compounds selected from the group consisting of 3-methacryloxypropyltriethoxysilane (MPTES), 3-methacryloxypropyltrimethoxysilane (MPTMS), and 3-acryloxypropyltrimethoxysilane.

In this case, a functional group of the organometallic compound can be cured by the externally supplied energy, so that the layer principally composed of the metal oxide can be easily formed on the light extraction surface.

The layer principally composed of the inorganic material may have a structure in which the inorganic material is dispersed in an organic polymer.

A method of fabricating a light emitting device according to still another aspect of the present invention comprises the steps of: forming a light emitting device structure including a light emitting layer and having a light extraction surface; and forming on the light extraction surface of the light emitting device structure a layer principally composed of an inorganic material different from a material constituting the light extraction surface that is optically transparent to a luminescent wavelength of the light emitting device structure and having unevenness on the surface opposite to the light extraction surface, wherein the step of forming the layer principally composed of the inorganic material includes the step of forming the unevenness by embossing.

In the light emitting device fabricated by the method according to the present invention, light produced from the light emitting layer of the light emitting device structure is emitted outside through the light extraction surface and the layer principally composed of the inorganic material having the unevenness. In this case, the inorganic material with the unevenness allows Fresnel reflection on the light extraction surface to be reduced. It is also possible for the refractive index of the layer principally composed of the inorganic material to be increased. This results in the sufficiently improved light extraction efficiency.

Moreover, there would be no defects in the light emitting device structure, because the layer principally composed of the inorganic material is formed on the light extraction surface that has not been processed itself. Thus, the degradation of characteristics of the light emitting device structure is prevented.

Further, the layer principally composed of the inorganic material with the unevenness can be easily formed on the light extraction surface without causing damage to the light extraction surface. This results in the reduced manufacturing cost.

The step of forming the layer principally composed of the inorganic material may include the step of forming the layer principally composed of the inorganic material layer by applying a solution on the light extraction surface of the light emitting device structure.

In this case, the layer principally composed of the inorganic material can be easily formed on the light extraction surface without causing damage to the light extraction surface.

The solution may be a solution in which fine particles are dispersed. The solution may also include an organic polymer in which fine particles are dispersed.

In this case, the layer principally composed of the fine particles can be easily formed on the light extraction surface without causing damage to the light extraction surface. Moreover, the formation of cracks on the layer principally composed of the inorganic material is prevented.

The fine particles may be composed of a metal oxide. In this case, the refractive index of the layer principally composed of the inorganic material can be easily increased.

The solution may include an organometallic polymer having an -M-O-M-bond, where M is a metal and O is an oxygen atom.

In this case, the layer principally composed of the metal oxide can be easily formed on the light extraction surface without causing damage to the light extraction surface.

The organometallic polymer may be synthesized from at least one kind of organometallic compounds having a hydrolytic organic group.

In this case, the layer principally composed of the metal oxide can be easily formed on the light extraction surface by a hydrolysis reaction of the organometallic compound.

The organometallic compound may be a metal alkoxide. In this case, the layer principally composed of the metal oxide can be easily formed on the light extraction surface by hydrolysis and polycondensation reactions of the metal alkoxide.

The organometallic compound may have functional groups directly or indirectly bonding to a metal atom, at least one of which can be cured by being subjected to externally supplied energy to be bridged.

In this case, a functional group of the organometallic compound is cured by the externally supplied energy, so that the layer principally composed of the metal oxide can be easily formed on the light extraction surface.

The externally supplied energy may be one of or both of energy by heating and energy by irradiation of light. In this case, the organometallic compound can be easily cured by heating or irradiation of light. This allows the layer principally composed of the metal oxide to be easily formed on the light extraction surface.

The organometallic compound may include at least one or more compounds selected from the group consisting of 3-methacryloxypropyltriethoxysilane (MPTES), 3-methacryloxypropyltrimethoxysilane (MPTMS), and 3-acryloxypropyltrimethoxysilane.

In this case, a functional group of the organometallic compound can be cured by the externally supplied energy, so that the layer principally composed of the metal oxide can be easily formed on the light extraction surface.

According to the present invention, the light extraction efficiency can be sufficiently improved without causing defects in the light emitting device structure.

Furthermore, the light extraction efficiency can be sufficiently improved by the use of embossing technique without causing defects in the light emitting device structure, while the reduced manufacturing cost is achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a method of fabricating a light emitting device according to a first embodiment of the present invention;

FIG. 2 is a diagram showing the method of fabricating the light emitting device according to the first embodiment of the present invention;

FIG. 3 is a diagram showing the method of fabricating the light emitting device according to the first embodiment of the present invention;

FIG. 4 is a diagram showing the method of fabricating the light emitting device according to the first embodiment of the present invention;

FIG. 5 is a diagram showing the method of fabricating the light emitting device according to the first embodiment of the present invention;

FIGS. 6(a), (b) are a schematic cross-section and a schematic plan view of a light emitting device according to a second embodiment of the present invention, respectively;

FIG. 7 is a schematic cross-section showing an example of the light emitting device structure;

FIG. 8 is a schematic cross-section showing another example of the light emitting device structure; and

FIG. 9 is a schematic cross-section showing a method of preparing a silicone rubber mold.

### DESCRIPTION OF THE PREFERRED EMBODIMENTS

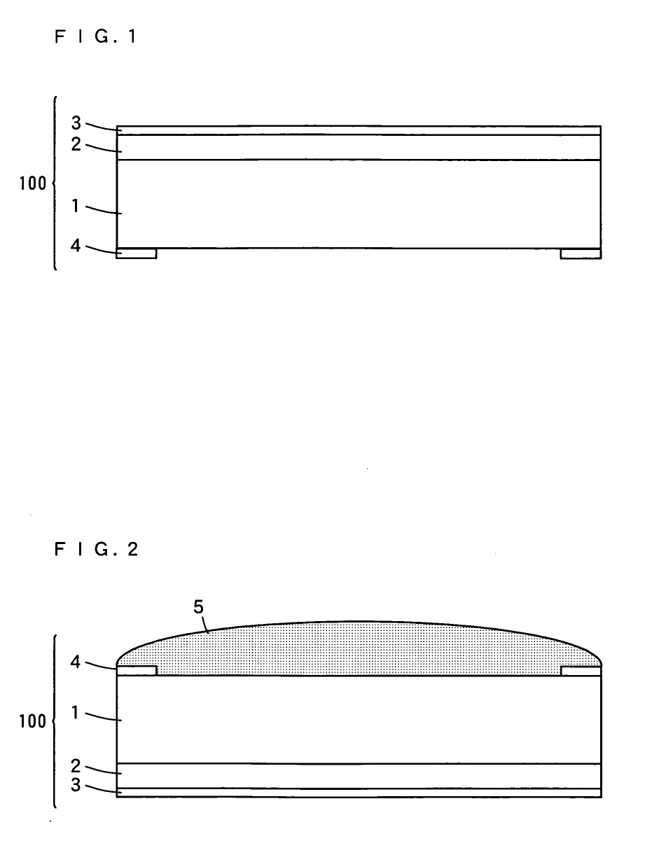

FIGS. 1 to 5 are diagrams each showing a light emitting device according to a first embodiment of the present invention. FIGS. 1 to 5(a) are schematic cross-sections, and FIG. 5(b) is a schematic plan view.

First, as shown in FIG. 1, a semiconductor layer 2 including a light emitting layer is formed on the main surface of a substrate 1. A detailed structure of the semiconductor layer 2 will be described below. Then, a p-electrode 3 is formed on the semiconductor layer 2, and an n-electrode 4 is formed on the back surface of the substrate 1. The n-electrode 4 is provided on the outer peripheral region except the rectangular region in the center. This results in the fabrication of a light emitting device structure 100.

The light emitting device structure 100 includes at least one semiconductor light emitting device. In this embodiment, the light emitting device structure 100 includes an LED. The light emitting device structure 100 may include a plurality of semiconductor light emitting devices.

In addition, the light emitting device structure 100 has at least one light extraction surface. The light extraction surface refers to the surface of a semiconductor light emitting device intended to be a light output surface. In this embodiment, the back surface of the substrate 1 acts as such a light extraction surface. The substrate 1 is accordingly made of a transparent substrate that transmits the light produced from the light emitting layer within the semiconductor layer 2. Note that the light emitting device structure 100 may have two or more light extraction surfaces.

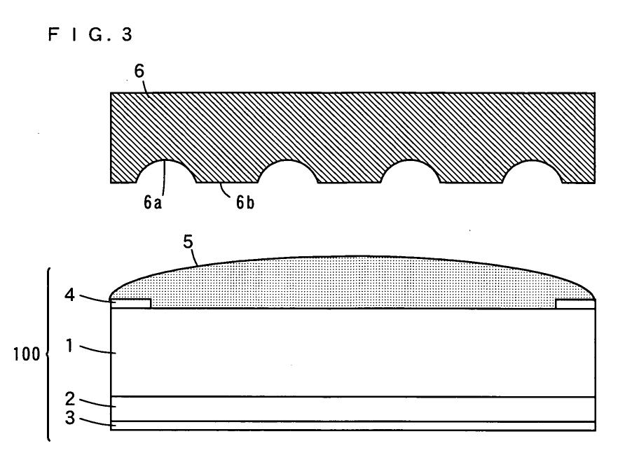

Next, as shown in FIG. 2, a pre-curing viscous solution (hereinafter referred to as a precursor solution) 5 is applied to the back surface of the substrate 1 for forming an optically transparent layer principally composed of an inorganic material.

As the precursor solution, a metal alkoxide or ceramic precursor polymer may be used. Alternatively, a colloidal solution in which fine particles composed of a metal oxide are dispersed may be used, for example. Examples of the precursor solution will later be mentioned.

Then, as shown in FIG. 3, a mold 6 is prepared. The mold 6 has unevenness on its one surface. The unevenness has recesses 6a and projections 6b. The method of preparing the mold 6 will later be described. The above-mentioned precursor solution may be applied to the unevenness in the mold 6. The precursor solution applied on the back surface of the substrate 1 or precursor solution on the mold 6 is heated or depressurized to be preliminarily molded in a gel state.

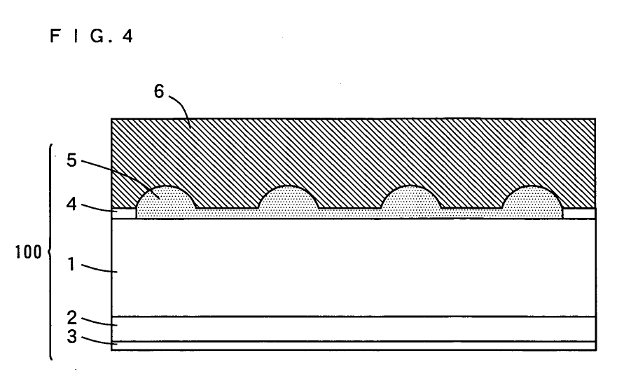

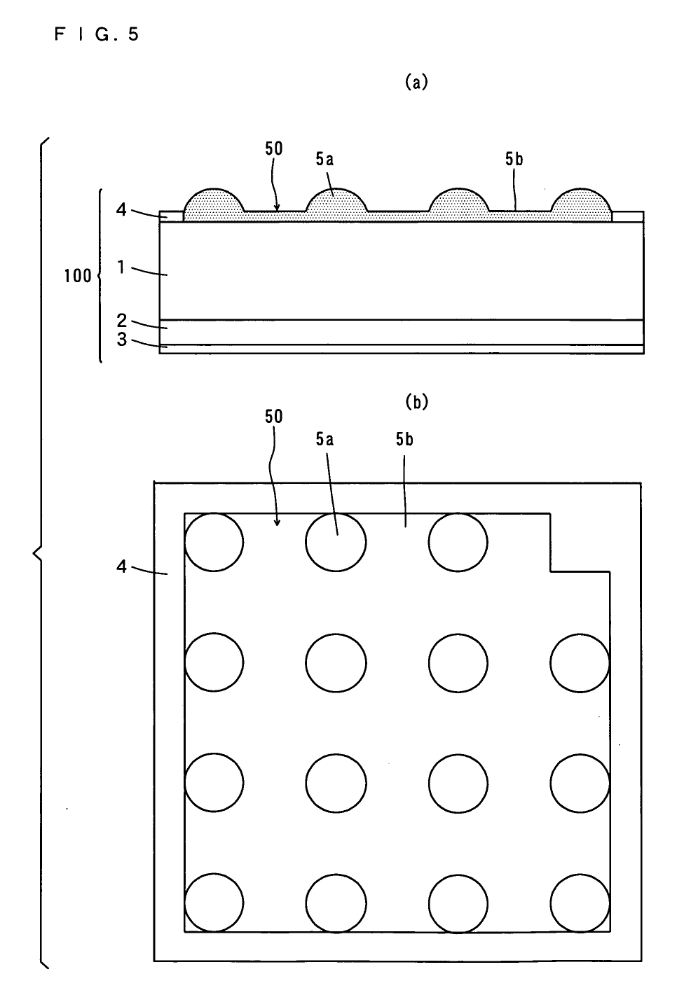

After this, as shown in FIG. 4, the substrate 1 is heated or irradiated with UV light while being pressed with the unevenness in the mold 6. This results in coalescence of the precursor solution gel on the substrate 1.

Then, as shown in FIG. 5, the mold 6 is removed from the substrate 1, so that an optically transparent layer principally composed of an inorganic material (hereinafter referred to as an inorganic material layer) 50 is formed on the substrate 1. On the surface of the inorganic material layer 50 are formed the unevenness having projections 5a and recesses 5b corresponding to the recesses 6a and projections 6b in the mold 6, respectively.

In this manner, the inorganic material layer 50 with the unevenness is formed on the back surface of the substrate 1 (i.e., light extraction surface) by embossing (i.e., a stamping process).

The projections 5a of the unevenness in this inorganic material layer 50 are extremely uniform, having only small irregularities in height. The projections 5a are highly uniform not only in height but also in their outer shape in general. In other words, the projections 5a are highly uniform also in width and depth.

The metal alkoxide used as the precursor solution is selected from: a silicon tetra-alkoxide, such as Si(OCH₃)₄, Si(OC₂H₅)₄, Si(i-OC₃H₇)₄, Si(t-OC₄H₉)₄; a single metal alkoxide, such as ZrSi(OCH₃)₄, Zr(OC₂H₅)₄, Zr(OC₃H₇)₄, Hf(OC₂H₅)₄, Hf(OC₃H₇)₄, VO(OC₂H₅)₃, Nb(OC₂H₅)₅, Ta(OC₂H₅)₅, Si(OC₄H₉)₄, Al(OCH₃)₃, Al(OC₂H₅)₃, Al(iso-OC₃H₇)₃, Al(OC₄H₉)₃, Ti(OCH₃)₄, Ti(OC₂H₅)₄, Ti(iso-OC₃H₇)₄, Ti(OC₄H₉)₄; a double metal alkoxide, such as La[Al(iso-OC₃H₇)₄]₃, Mg[Al(iso-OC₃H₇)₄]₂, Mg[Al(sec-OC₄H₉)₄]₂, Ni[Al(iso-OC₃H₇)₄]₂, Ba[Zr₂(C₂H₅)₉]₂, (OC₃H₇)₂Zr[Al(OC₃H₇)₄]₂; and a polymetal alkoxide containing three or more kinds of metals.

In a sol-gel process, a metal alkoxide that is a kind of organometallic compounds is used as the starting material, and dissolved in a solvent such as alcohol. Then, the resultant solution is mixed well with the addition of a catalyst of an acid or the like and a small amount of water for hydrolysis and condensation polymerization to form sol. Following this, the sol is allowed to proceed with subsequent reactions with moisture in air and the like, to be formed into gel. This results in a solid-state metal oxide.

As the metal alkoxide, any of the above examples may be used. In general, a metal alkoxide represented by M(OR)ₙ, where M is a metal, R is an alkyl group, n is 2, 3, 4 or 5; R′M(OR)ₙ₋₁, where M is a metal, R is an alkyl group, R′ is an organic group, n is 2, 3, 4 or 5; or R2′M(OR)ₙ₋₂, where M is a metal, R is an alkyl group, R′ is an organic group, n is 2, 3, 4 or 5, may be used.

Examples of M may include, as mentioned above, Si (silicon), Ti (titanium), Zr (zirconium), Al (aluminum), Sn (tin), and Zn (zinc). One example of R is an alkyl group at carbon number 1 to 5. Examples of R′ may include an alkyl group, an aryl containing group, an acryloxy containing group, a methacryloxy containing group, a styryl containing group, and an epoxy containing group.

Note that the aryl containing group means an organic group containing an aryl group; the acryloxy containing group means an organic group containing an acryloxy group; the methacryloxy containing group means an organic group containing a methacryloxy containing group; the styryl containing group means an organic group containing a styryl containing group; and the epoxy containing group means an organic group containing an epoxy containing group.

With M being a quardivalent metal, it is possible to employ a metal alkoxide represented by M(OR)₄, where M is a metal, R is an alkyl group; R′M(OR)₃, where M is a metal, R is an alkyl group, R′ is an alkyl group, aryl containing group, acryloxy containing group, methacryloxy containing group, styryl containing group or epoxy containing group; or Rₘ′M(OR)₄₋ₘ, where M is a metal, R is an alkyl group, R′ is an alkyl group, aryl containing group, acryloxy containing group, methacryloxy containing group, styryl containing group or epoxy containing group, m is 1, 2 or 3, may be used.

As a metal alkoxide particularly preferable for use, there may be mentioned: tetraethoxysilane, tetramethoxysilane, phenyltriethoxysilane, phenyltrimethoxysilane (PhTMS), diphenyldiethoxysilane, diphenyldimethoxysilane, MPTES, MPTMS, 3-methacryloxypropylmethyldimethoxysilane, 3-acryloxypropyltritrimethoxysilane or the like.

The metal alkoxide as used in the present invention includes so called organoalkoxysilane and a silane coupling agent.

As the ceramic precursor polymer, one ore more materials selected from poly(isopropyliminoalane), polytitanosiloxane, and the like may be used. Poly(isopropyliminoalane) is a soluble ceramic precursor, capable of synthesizing aluminum nitride by pyrolysis.

Instead of the metal alkoxide or ceramic precursor polymer, a metal oxide may be obtained using an aqueous solution such as titanium peroxycitric acid ammonium ((NH₄)₄[Ti₂(C₆H₄O₇)₄(O₂)₄]), zirconium peroxycitric acid ammonium ((NH₄)₄[Zr₂(C₆H₄O₇)₄(O₂)₄]), hafnium peroxycitric acid ammonium ((NH₄)₄[Hf₂(C₆H₄O₇)₄(O₂)₄]) or tin peroxycitric acid ammonium ((NH₄)₄[Sn₂(C₆H₄O₇)₄(O₂)₄]); an alcohol solution; a glycol solution; a glycerin solution; or a mixed solution thereof. Alternatively, a metal oxide may be obtained using peroxotitanium acid or the like.

As an alternative, a colloidal solution composed of fine particles (particle diameter of 3 nm to 200 nm, for example) of TiO₂, ZrO₂, HfO₂, ZnO, Nb₂ O₅, Ta₂ O₅ or the like may be used as the precursor solution.

The inorganic material layer 50 may contain a phosphor substance that may permit transmission of light produced from the light emitting layer, and absorb the light from the light emitting layer for conversion to other luminescent wavelengths.

The size of the unevenness in the inorganic material layer 50 may be smaller than that of the luminescent wavelength, or may be on the order of the luminescent wavelength, or greater than the luminescent wavelength. Description is given of a case where the luminescent wavelength is 400 nm.

In cases where the size of the unevenness is smaller than the luminescent wavelength in size (e.g., 50 to 150 nm), the effect of reducing Fresnel reflection on the interface between the light emitting device structure 100 and the outside (i.e., the interface between the light emitting device structure 100 and the resin mold or between the light emitting device structure 100 and the air) is observed. Note that Fresnel reflection refers to a reflection on the interface between substances having different refractive indices.

In cases where the size of the unevenness is on the order of or several times the luminescent wavelength (e.g., 200 to 1000 nm), the light that does not exit from the light emitting device structure 100 due to total reflection can be emitted outside through a diffraction effect.

In cases where the size of the unevenness is greater than the luminescent wavelength in size (e.g., 2 to 50 μm), light can easily enter the uneven surface at a critical angle or less, leading to an increase in the light emitted outside.

It is also preferable that the inorganic material layer 50 has a refractive index not smaller than that of the material of the light extraction surface in the light emitting device structure 100. This is because, in cases where the refractive index of the inorganic material layer 50 is smaller than that of the light extraction surface material of the light emitting device structure 100, the light incident on the interface between the inorganic material layer 50 and light extraction surface at an angle greater than the critical angle fails to enter the inorganic material layer 50. This is particularly the case, as the thickness of the unevenness (i.e., the height of a projecting portion 5a) increases.

In cases where the inorganic material layer 50 has a refractive index greater than that of the light extraction surface material of the light emitting device structure 100, there is no critical angle. If, however, the difference between the refractive indices of the inorganic material layer 50 and the light extraction surface material is too large, Fresnel reflection on the interface between the inorganic material layer 50 and the light extraction surface becomes so large as to decrease the light extraction efficiency. It is therefore most preferable that the refractive index of the inorganic material layer 50 and the refractive index of the light extraction surface material of the light emitting device structure 100 are almost equal to each other.

In the above-described embossing technique, however, an inorganic material tends to be formed in a somewhat low density, so that the refractive index of the formed inorganic material layer 50 is often somewhat smaller than the ideal refractive index of an inorganic material layer. It is, therefore, preferable to choose for the inorganic material layer 50 a material having a somewhat higher refractive index than that of the material of the light extraction surface of the light emitting device structure 100.

Where a plurality of light emitting devices are formed on the substrate 1 as light emitting device chips, followed by separation of the individual light emitting device chips, it is preferable that the thickness of the inorganic material layer 50 is decreased among the light emitting device chips or that the inorganic material layer 50 is separated among the light emitting device chips. When the inorganic material layer 50 is formed over the entire substrate 1 by the above-described embossing, the inorganic material layer 50 easily cracks because of shrinkage. When the thickness of the inorganic material layer 50 is on the other hand decreased among light emitting device chips or the inorganic material layer 50 is separated among light emitting device chips, the edges of the inorganic material layer 50 on each light emitting device chip can easily shrink; so that the light extraction surfaces of the light emitting device chips shrink less resulting in fewer cracks.

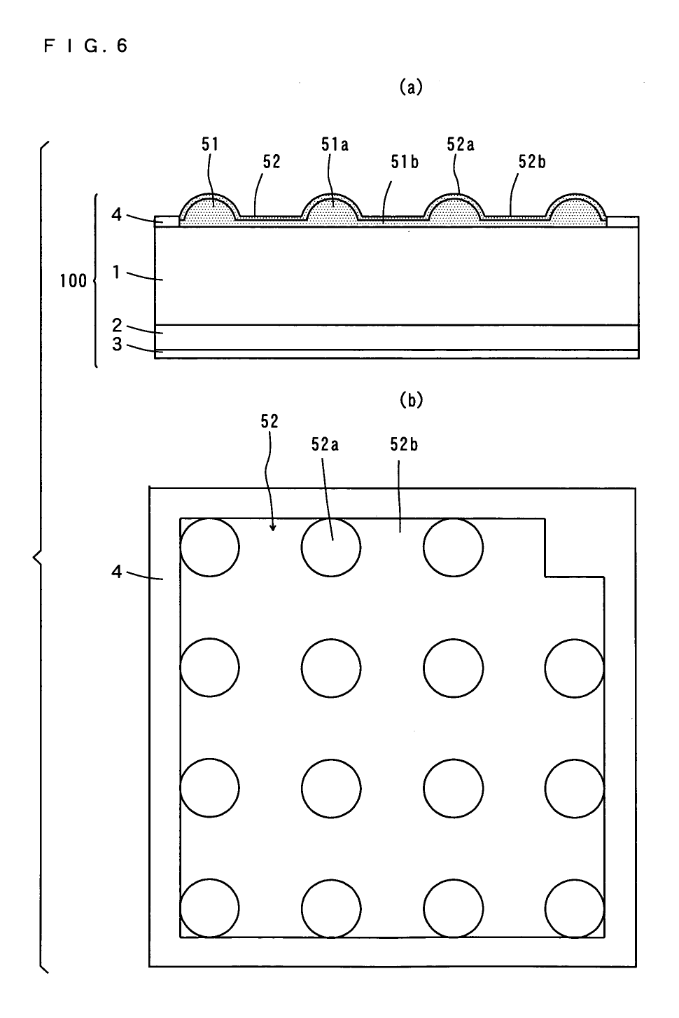

FIGS. 6(a), (b) are a schematic cross-section and a schematic plan view of a light emitting device according to a second embodiment of the present invention, respectively.

In the light emitting device of FIG. 6, an inorganic material layer 51 and an inorganic material layer 52 are laminated on the light extraction surface of the substrate 1. On the surfaces of the respective inorganic material layers 51, 52 are formed unevenness having projections 51a, 52a and recesses 51b, 52b. Three or more inorganic material layers may be laminated on the light extraction surface of the substrate 1.

It is preferable that the inorganic material layer 51 on the side of the light extraction surface of the light emitting device structure 100 is formed by a material with a high refractive index. This decreases Fresnel reflection on the interface between the light extraction surface of the light emitting device structure 100 and the inorganic material layer 51.

One characteristic of the sol-gel process is that it is difficult to form thick layers. This is due to the fact that as the thickness of a layer increases, the difference between the degrees of reaction progress on the surface of the layer and inside the layer is likely to increase. In other words, the surface of the layer becomes gel or solid, while the reaction is not proceeding inside the layer, so that the surface of the layer is subjected to a tensile stress, easily causing cracks to be formed on the surface of the layer. Such a tensile stress tends to increase with an increase in the thickness of the layer. Thus, the formation of a thick layer is difficult in the sol-gel process. Lamination of a plurality of organic material layers makes it easier to fabricate a thick inorganic material layer.

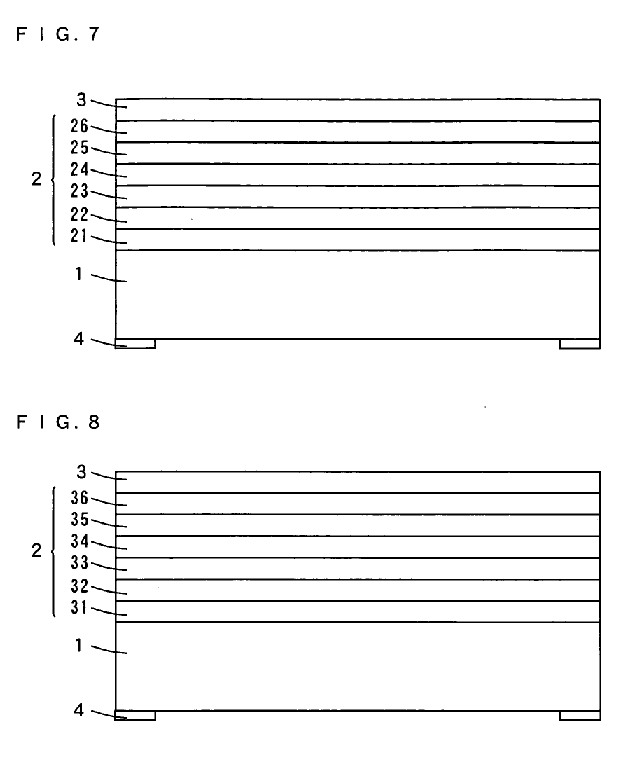

FIG. 7 is a schematic cross-section showing an example of the light emitting device structure 100.

In this example, the light emitting device structure 100 is an LED including a gallium nitride-based compound semiconductor that emits at wavelengths of 365 nm to 550 nm. Here, description is made of a method for fabricating a GaN-based UV LED whose luminescent wavelength peaks at about 390 nm to 420 nm.

As a substrate 1, an n-type GaN (0001) substrate, doped with oxygen, Si (silicon) or the like and having a thickness of 200 to 400 μm, is prepared. With the substrate 1 being held at a single-crystal growth temperature of, preferably 1000 to 1200° C., e.g., at 1150C., an n-type layer 21 made of single-crystal Si doped GaN in a thickness of 5 μm is grown on the (0001) Ga face of the substrate 1 at a growth rate of about 3 μm/h, using a carrier gas including H₂ and N₂ (the content of H₂ being about 50%), a source gas of NH₃ and TMGa, and a dopant gas of SiH₄.

After this, with the substrate 1 being held at a single-crystal growth temperature of, preferably 1000 to 1200° C., e.g., at 1150° C., an n-type cladding layer 22 made of single-crystal Si doped Al_{0.1}Ga_{0.9}N in a thickness of 0.15 μm is grown on the n-type layer 21 at a growth rate of about 3 μm/h, using a carrier gas including H₂ and N₂ (the content of H₂ being about 1 to 3%), a source gas of NH₃, trimethylgallium (TMGa), and trimethylaluminum (TMAl), and a dopant gas of SiH₄.

Then, with the substrate 1 held at a single-crystal growth temperature of, preferably 700 to 1000° C., e.g., at 850° C., 5 nm thick barrier layers (six layers) made of single-crystal undoped GaN and 5 nm thick well layers (five layers) made of single-crystal undoped Ga_{0.9}In_{0.1}N are alternately grown on the n-type cladding layer 22, using a carrier gas including H₂ and N₂ (the content of H₂ being about 1 to 5%), and a source gas of NH₃, triethylgallium (TEGa) and trimethylindium (TMIn), so as to grow a light emitting layer 23 having the multiple quantum well (MQW) structure at a growth rate of about 0.4 nm/s, after which a protective layer 24 made of single-crystal undoped GaN in a thickness of 10 nm is successively grown at a growth rate of about 0.4 nm/s.

Subsequently, with the substrate 1 held at a single-crystal growth temperature of, preferably 1000 to 1200° C., e.g., at 150° C., a p-type cladding layer 25 made of single-crystal Mg doped Al_{0.1}Ga_{0.9}N in a thickness of 0.15 μm is grown on the protective layer 24 at a growth rate of about 3 μm/h, using a carrier gas including H₂ and N₂ (the content of H₂ being about 1 to 3%), a source gas of NH₃, TMGa, and TMAl, and a dopant gas of Cp₂Mg.

Following this, with the substrate 1 held at a single-crystal growth temperature of, preferably 700 to 1000° C., e.g., at 850° C., a p-type contact layer 26 made of Mg doped Ga_{0.95}In_{0.05}N in a thicknes of 0.3 μm is grown on the p-type cladding layer 25 at a growth rate of 3 μm/h, using a carrier gas including H₂ and N₂ (the content of H₂ being about 1 to 5%), a source gas of NH₃, TEGa, TMIn, and a dopant gas of Cp₂Mg.

The p-type semiconductor layer of high carrier concentration can be obtained, by decreasing the composition of hydrogen in the carrier gas thereby activating the Mg dopant without heat-treating it in an N₂ atmosphere, during the crystal growth of the above p-type cladding layer 25 to the p-type contact layer 26.

The n-type layer 21, n-type cladding layer 22, light emitting layer 23, protective layer 24, p-type cladding layer 25, and p-type contact layer 26 constitute a semiconductor layer 2.

An ohmic electrode made of Ni, Pd or Pt is formed over the almost entire surface of the p-type contact layer 26; for example, a 2 nm thick Pd film is formed on the p-type contact layer 26. After this, a metal film made of Ag or Al having a high reflectivity is formed; for example, a 50 nm thick Ag film is formed. In addition, as a protective layer, a precious-metal thin film or Indium Tin Oxide (ITO) or the like is formed; for example, a 5000 nm thick Au film is formed. This results in the formation of a p-electrode 3 on the upper surface of the semiconductor layer 2.

Then, an ohmic electrode, a barrier metal film, and a pad metal film are, in sequence, laminated on the outer peripheral region of the back surface of the substrate 1 by for example vacuum vapor deposition, to form an n-electrode 4. As the ohmic electrode, Al or Ag (20 nm thickness) is used. As the barrier metal film, Pt, Ti or the like (50 nm thickness) is used so as to suppress a reaction of the ohmic electrode with the pad metal film. As the pad metal film, a precious-metal film or ITO or the like is used; for example, a 5000 nm thick Au film is formed.

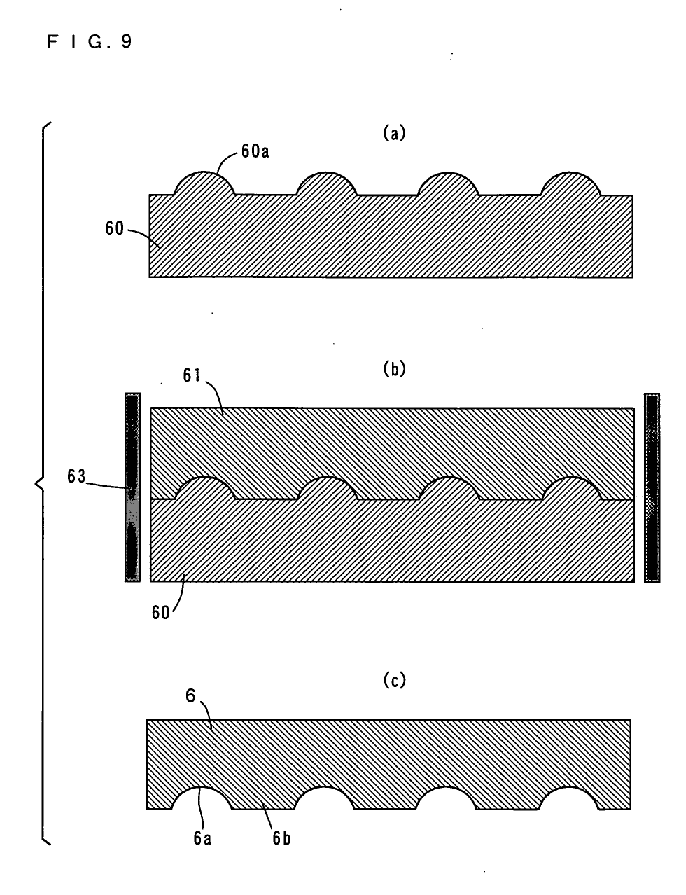

FIG. 8 is a schematic cross-section showing another example of the light emitting device structure 100.

In this example, the light emitting device structure 100 is an LED made of a zinc oxide-based compound semiconductor that emits light at wavelengths of 365 nm to 550 nm. Description is now made of a method for fabricating a ZnO-based UV LED whose luminescent wavelength peaks at about 390 nm to 420 nm.

As a substrate 1, an n-type GaN (0001) substrate, doped with oxygen, Si or the like and having a thickness of 200 to 400 μm, is prepared. On the (0001) Ga face of the substrate 1, an n-type layer 31 made of Ga doped n-type ZnO in a thickness of about 4 μm is grown by a Metal Organic Vapor Phase Epitaxy (MOVPE) technique at a growth rate of about 0.08 μm/s and at a growth temperature of 500 to 700° C., using hydrogen as carrier gas.

After this, an n-type cladding layer 32 made of Ga doped n-type Mg_{0.05}Zn_{0:95}O in a thickness of about 0.45 μm is grown on the n-type layer 31 at a growth temperature of 500 to 700° C.

Then, a light emitting layer 33 having an MQW structure including four 20 nm thick barrier layers made of Cd_{0.1}Zn_{0.9}O, and three 3 nm thick well layers made of Cd_{0.05}Zn_{0.95}O is grown on the n-type cladding layer 32 at a growth temperature of 400 to 450° C.

In addition, a p-type carrier blocking layer 34 made of nitrogen doped p-type Mg_{0.15}Zn_{0.85}O in a thickness of about 20 nm, and a p-type cladding layer 35 made of nitrogen doped p-type Mg_{0.05}Zn_{0.95}O in a thickness of about 0.2 μm are grown on the light emitting layer 33 at a growth temperature of 500 to 700° C.

Then, a p-type contact layer 36 made of nitrogen doped p-type ZnO in a thickness of about 0.15 μm is grown on the p-type cladding layer 35 at a growth temperature of 500 to 700° C.

After this, the semiconductor layer is annealed at a temperature of 700° C. in an inert atmosphere such as nitrogen, argon or under vacuum, thereby having its hydrogen extracted, so that the carrier concentrations of the p-type carrier blocking layer 34, p-type cladding layer 35, and p-type contact layer 36 are increased.

The n-type layer 31, n-type cladding layer 32, light emitting layer 33, carrier blocking layer 34, p-type cladding layer 35, and p-type contact layer 36 constitute the semiconductor layer 2.

Although in the above embodiment, the LEDs made of a nitride-based semiconductor and a zinc oxide-based compound semiconductor have been described as light emitting devices, the present invention is not limited to those above, and may be applied similarly to various light emitting devices such as an LED made of other inorganic semiconductor or an LED made of an organic semiconductor.

In addition, in the above embodiment, each of the layers in the light emitting device structure 100 is stacked on the (0001) face of the n-type GaN substrate; however, layers may be stacked instead on a face having another plane direction of a hexagonal substrate of GaN or the like. Each of the layers may be stacked on a face represented by (H, K, —H—K, 0), where H and K each is an integer, and at least either of them is not zero; for example, on the (1-100) or (11-20) face. In this case, a piezo-electric field is not produced in the light emitting layer, so that the light emitting efficiency of the light emitting layer can be enhanced. Alternatively, a substrate misorientated in each plane direction (i.e., off substrate) may be used.

In the above embodiment, the use of the light emitting layers 13, 23 having the MQW structure has been demonstrated; however, the use of a single light emitting layer having large thickness without a quantum effect or the use of a light emitting layer having a single quantum well structure may also result in the similar effect obtained in the present embodiment.

In the above embodiment, the crystal structure of a semiconductor may be either the wurtzite structure or the zinc blende structure.

In the above embodiment, the crystal growth of the semiconductor layer 2 is accomplished using an MOVPE technique, for example; however, other techniques such as a Hydride Vapor-Phase Epitaxy (HVPE) technique, a Molecular Beam Epitaxy (MBE) technique or a gas source MBE technique may be used for the crystal growth of the semiconductor layer 2.

In the above embodiment, the back surface of the substrate is intended to be the light extraction surface; however, the front surface of the semiconductor layer may be designed to be the light extraction surface, the layer principally composed of the inorganic material being formed on the front surface of the semiconductor layer, while having unevenness on the surface opposite to the light extraction surface.

As an alternative, the layer principally composed of the inorganic material may be formed on the light extraction surface with a transparent electrode sandwiched therebetween.

### EXAMPLES

The present invention will, hereinafter, be described in more detail through Examples, by which the invention shall not be limited.

In Inventive Examples 1 to 5 and 7 to 10, light emitting devices having the structure shown in FIGS. 1 to 5 were fabricated, whereas in Inventive Example 6, a light emitting device having the structure shown in FIG. 6 was fabricated. The light emitting device structures 100 of the light emitting devices in the Inventive Examples 1, 2, 4 to 10 are the GaN-based LEDs as shown in FIG. 7. The light emitting device structure 100 of the light emitting device in the Inventive Example 3 is the ZnO-based LED as shown in FIG. 8.

In Comparative Example, a light emitting device having the light emitting device structure 100 as shown in FIG. 7, without an inorganic material layer, was fabricated.

The light emitting devices measure 1 mm per side. In each of the light emitting devices, an n-electrode 4 was formed on the outer peripheral region of 50 μm in width and one corner of 100 μm per side. The one corner of 100 μm per side was provided for electrical connection between the n-electrode 4 of the light emitting device and the outside through wire bonding or the like.

(Preparation of Silicone Rubber Mold)

In the Inventive Examples 1 to 5, 7 to 10, a mold of silicone rubber prepared as follows was used as a mold 6. In the Inventive Example 6, a Si mold was used as a mold 6.

FIG. 9 is a schematic cross-section view showing a method for preparing the silicone rubber mold.

As shown in FIG. 9(a), a Si mold 60 that is the main mold was prepared. The Si mold 60 has a plurality of projections 60a in a shape of nearly spherical surface.

As shown in FIG. 9(b), the Si mold 60 was placed inside the mold frame 63. A transparent solution 61 of silicone rubber was then poured into the mold frame 63 to be cured, resulting in the mold 6 made of a silicone rubber mold as shown in FIG. 9(c). The mold 6 has a plurality of nearly semi-spherical recesses 6a. Flat projections 6b are formed between the plurality of recesses 6a.

### (Inventive Example 1)

(1) Preparation of Precursor Solution (Zirconium Peroxycitric Acid Ammonium Solution)

5 g of zirconium peroxycitric acid ammonium was mixed with 2.5 g of water and 2.5 g of propylene glycol.

(2) Application of Precursor Solution

The precursor solution was applied onto the back surface of the substrate 1 of the light emitting device structure 100 by spin coating. Instead of spin coating, dip coating may be used. The substrate 1 to which the precursor solution was applied was left at room temperature for 30 minutes to be air-seasoned, with the precursor solution being adjusted in the desired thickness.

As a mold 6, a silicone rubber mold with a plurality of recesses 6a in a shape of nearly spherical surface, having a pitch of 100 nm, a radius of curvature of 50 nm, and a depth of 50 nm, was used. Note that the recesses 6a are not formed on the part of the mold 6 corresponding to the n-electrode 4 of the light emitting device structure 100.

The precursor solution was applied to the mold 6 by spin coating. Instead of spin coating, dip coating may be used. This precursor solution was air-seasoned at room temperature for 30 minutes.

(3) Gelation

The substrate 1 and mold 6 to which the precursor solution was applied were elevated to a given temperature to be preliminarily molded. The preliminary molding was performed for 30 minutes at a temperature of 50° C., so as to prevent the formation of cracks.

(4) Formation of Unevenness

Following this, the gel inside the mold 6 and the gel on the back surface of the substrate 1 were brought into contact with each other while being pressed with the mold 6 for coalescence, and heated to be permanently molded.

The permanent molding was performed for an hour, with the pressing force set to 2 to 2.5 kgf/cm², and the temperature to 200° C.

As a result, projections 5a made of ZrO₂ having a pitch of 100 nm were formed on the back surface of the substrate 1.

In the light emitting device of the Inventive Example 1, the inorganic material layer 50 with the unevenness allows a decrease in Fresnel reflection, so that the light extraction efficiency is enhanced by 15% as compared to the Comparative example.

### (Inventive Example 2)

(1) Preparation of Precursor Solution (Pentaethoxyniobium Solution)

7 g of Pentaethoxyniobium was mixed with 1 g of ethanol. This solution was mixed with 2 g of diluted hydrocholoric acid (water soluble solvent) having a concentration of 0.2% by weight, to prepare 10 g of pentaethoxyniobium solution having a concentration of 70% by weight.

(2) Application of Precursor Solution

The precursor solution was applied onto the back surface of the substrate 1 of the light emitting device structure 100 by spin coating. Instead of spin coating, dip coating may be used. The substrate 1 to which the precursor solution was applied was left at room temperature for 30 minutes to be air-seasoned, with the precursor solution adjusted in the desired thickness.

As a mold 6, a silicone rubber mold with a plurality of recesses 6a in a shape of nearly spherical surface, having a pitch of 400 nm, a radius of curvature of 200 nm, and a depth of 200 nm, was used. Note that the recesses 6a are not formed on the part of the mold 6 corresponding to the n-electrode 4 of the light emitting device structure 100.

The precursor solution was applied to the mold 6 by spin coating. Instead of spin coating, dip coating may be used. This precursor solution was air-seasoned for 30 minutes.

(3) Gelation

The substrate 1 and mold 6 to which the precursor solution was applied were placed in a vacuum chamber, and elevated to a given temperature under reduced pressure, to be preliminarily molded. The preliminary molding was performed at a back pressure of 1×10⁻² Pa for 30 minutes, with the temperature set to 50° C., so as to prevent the formation of cracks.

(4) Formation of Unevenness

Following this, the gel inside the mold 6 and the gel on the back surface of the substrate 1 were brought into contact with each other while being pressed with the mold 6 for coalescence, and heated under reduced pressure to be permanently molded.

The permanent molding was performed under a reduced pressure of 1×10⁻² Pa for an hour, with the pressing force set to 2 to 2.5 kgf/cm² and the temperature to 80° C.

As a result, projections 5a made of Nb₂O₅ with a pitch of 400 nm were formed on the back surface of the substrate 1.

In the light emitting device of the Inventive Example 2; some of the light that does not exit from the light emitting device structure 100 due to total reflection can be emitted outside through a diffraction effect. Consequently, the light extraction efficiency is nearly twice that of the light emitting device in the Comparative Example.

### (Inventive Example 3)

(1) Preparation of Precursor Solution (Pentaethoxy tantalum Solution)

7 g of pentaethoxy tantalum was mixed with 1 g of ethanol. This solution was mixed with 2 g of diluted hydrocholoric acid (water soluble solvent) having a concentration of 0.2% by weight, to prepare 10 g of pentaethoxy tantalum having a concentration of 70% by weight.

The precursor solution was mixed with a resin having a high refractive index. Mixing of the resin can reduce the formation of cracks after molding. With a large proportion of the resin, the effect of reducing cracks is significant while the refractive index is lowered. In contrast, with a small proportion of the resin, the effect of reducing cracks is small while a high refractive index close to that of an inorganic material can be obtained.

As resins having high refractive indices, there may be mentioned: a silicone resin (refractive index: about 1.41), polymethyl methacrylate (PMMA) (refractive index: about 1.5), polypentabromophenyl methacrylate (refractive index: 1.71), polyvinyl naphthalene (refractive index: 1.68), and the like. An organic polymer resin has a refractive index of about 1.7 at most. In this Inventive Example, PMMA (refractive index: 1.5) was used as the resin.

Steps (2) Through (4)

As a mold 6, a silicone rubber mold having a plurality of recesses 6a in a shape of nearly spherical surface, having a pitch of 1000 nm, a radius of curvature of 500 nm, and a depth of 500 nm, was used.

Similar steps to (2) through (4) in the Inventive Example 2 were carried out to form projections 5a made of Ta₂O₅ on the back surface of the substrate 1.

In the light emitting device of the Inventive Example 3, some of the light that does not exit from the light emitting device structure 100 due to total reflection can be emitted outside through a diffraction effect. Consequently, the light extraction efficiency is nearly twice that of the light emitting device in the Comparative Example.

### (Inventive Example 4)

(1) Preparation of Precursor Solution (Colloidal Solution of Fine Particles of TiO₂ (Anatase- or Rutile-Type))

It is preferable that fine particles of TiO₂ have a smaller particle diameter than that of the luminescent wavelength; for example, 50 to 150 nm.

In this Inventive Example, as a colloidal solution of fine particles of TiO₂, isopropyl alcohol containing 30% by weight of TiO₂ was used.

(2) Application of Precursor Solution

The precursor solution (colloidal solution) was applied to the back surface of the substrate 1 by spin coating. Instead of spin coating, dip coating may be used. The substrate to which the precursor solution was applied was left at room temperature for 30 minutes to be air-seasoned, with the precursor solution being adjusted in the desired thickness.

As a mold 6, a silicone rubber mold with a plurality of recesses 6a in a shape of nearly spherical surface, having a pitch of 3 μm, a radius of curvature of 2 μm, and a depth of 1.5 μm, was used. Note that the recesses 6a are not formed on the part of the mold 6 corresponding to the n-electrode 4 of the light emitting device structure 100.

The precursor solution was applied to the mold 6. Instead of spin coating, dip coating may be used. The precursor solution was air-seasoned at room temperature for 30 minutes.

(3) Gelation

The substrate 1 and mold 6 to which the precursor solution was applied was elevated to a given temperature to be preliminarily molded. The preliminary molding was performed for 30 minutes, at a temperature of 50° C., so as to prevent the formation of cracks.

(4) Formation of Unevenness

Following this, the mold 6 and the back surface of the substrate 1 were brought into contact with each other while being pressed with the mold 6 for coalescence, and heated to be permanently molded. The permanent molding was performed for an hour, with the pressing force set to 2 to 2.5 kgf/cm², and the temperature to 200° C.

As a result, recesses 5a composed of TiO₂ fine particles with a pitch of 3 μm were formed on the back surface of the substrate 1.

In the light emitting device of the Inventive Example 4, light can easily enter, at a critical angle or less, the projections 5a with a pitch of 3 μm on the inorganic material layer 50, leading to an increase in the amount of light emitted outside. In addition, unevenness as small as 50 to 150 nm, inherently possessed by the fine particles themselves, are formed on the surface of the projections 5a; so that Fresnel reflection on the surface of the projections 5a can be decreased. As a result, the light emitting device in the Inventive Example 4 has a light extraction efficiency improved by about 120%, as compared to the light emitting device in the Comparative Example.

### (Inventive Example 5)

(1) Preparation of Precursor Solution (Mixed Solution)

5 g of titanium peroxycitric acid ammonium was mixed with 2.5 g of water. Additionally, a phosphor that converts UV light to visible light was mixed into this solution. As the phosphor, YAG (Yttrium Aluminum Garnet), Y₃A1₅O₁₂, a calcium halophosphate-based, calcium phosphate-based, silicate-based, aluminate-based, or tungstate-based material, or the like, with the addition of Ce (cerium) as an activator, may be used. The resultant solution and the solution in the Inventive Example 4 were mixed.

Steps (2) Through (4)

As a mold 6, a silicone rubber mold having a plurality of recesses 6a in a shape of nearly spherical surface, having a pitch of 10 μm, a radius of curvature of 7 μm, and a depth of 2 μm, was used.

Similar steps to (2) through (4) in the Inventive Example 4 were carried out.

In the Inventive Example 5, gaps among the fine particles of TiO₂ were almost filled with TiO₂ produced by the decomposition of titanium peroxycitric acid ammonium. This allowed TiO₂ to be more densely formed than that in the Inventive Example 4, leading to a higher refractive index.

Also, the adhesion between particles was stronger than that in the Inventive Example 4, so that the formed unevenness were highly stable.

In addition, fine particles of TiO₂ shrink less than when only titanium peroxycitric acid ammonium is used to form a similar structure; so that the shrinkage can be decreased to suppress the formation of cracks by mixing fine particles of TiO₂ into the precursor solution.

As a result, projections 5a composed of TiO₂ were formed with a pitch of 10 μm on the back surface of the substrate 1.

In the light emitting device of the Inventive Example 5, light can easily enter the projections 5a on the inorganic material layer 50 at a critical angle or less, with an increase in the amount of light emitted outside. In addition, TiO₂ is more densely formed than that in the light emitting device of the Inventive Example 4, resulting in a higher refractive index. As a result, the light emitting device of the Inventive Example 5 has a light emitting efficiency improved by about 150% as compared to that of the light emitting device of the Comparative Example.

### (Inventive Example 6)

(1) Formation of Inorganic Material Layer 51

5 g of titanium peroxycitric acid ammonium was mixed with 2.5 g of water. This solution was mixed with the solution of the Inventive Example 4 to prepare a first precursor solution. Using the first precursor solution, similar steps to those of the Inventive Example 4 were carried out.

As a mold 6, a Si mold having a plurality of recesses 6a in a shape of nearly spherical surface having a pitch of 15 μm, a radius of curvature of 15 μm, and a depth of 2.5 μm, was used.

As a result, projections 51a composed of TiO₂ with a pitch of 15 μm were formed on the back surface of the substrate 1.

(2) Formation of Inorganic material layer 52

Next, 5 g of zirconium peroxycitric acid ammonium was mixed with 2.5 g of water and 2.5 g of propylene glycol to prepare a second precursor solution.

The second precursor solution was applied to the projections 5a composed of TiO₂ by spin coating. Instead of spin coating, dip coating may be used. The substrate 1 to which the second precursor solution was applied was left at room temperature for 30 minutes to be air-seasoned, with the second precursor solution being adjusted in the desired thickness.

As a mold 6, a Si mold having a plurality of recesses 6a in a shape of nearly spherical surface having a pitch of 15 μm, a radius of curvature of 11 μm, a depth of 3 μm, was used.

The second precursor solution was applied to the mold 6 by spin coating. Instead of spin coating, dip coating may be used. The second solution was air-seasoned at room temperature for 30 minutes.

As a result, projections 51a, 52a composed of TiO₂ and ZrO₂, respectively, in sequence from the side of the substrate 1, were formed with a pitch of 15 μm on the back surface of the substrate 1.

In the light emitting layer of the Inventive Example 6, light easily enters the projections 51a, 52a at a critical angle or less, resulting in an increase in the amount of light emitted outside. In addition, Fresnel reflection can be decreased, because the inorganic material layers 51, 52 are composed of TiO₂ and ZrO₂, respectively in sequence from the side of the substrate 1, with the inorganic material layer 51 composed of the material with a high refractive index on the side of the light emitting device structure 100. As a result, the light emitting device in the Inventive Example 6 has a light emitting efficiency improved by 170% as compared to the light emitting device of the Comparative Example.

### (Inventive Example 7)

(1) Preparation of Precursor Solution

5.6 ml of MPTES, 5.8 ml of PhTMS, 1.65 ml of hydrochloric acid with a concentration of 2 N, and 21 ml of ethanol were mixed, and left for 24 hours to allow hydrolysis and condensation polymerization of MPTES and PhTMS to proceed. Then, 4 ml of the resultant solution was put in a petri dish, and heated at 100° C. to remove ethanol by evaporation, resulting in about 1 g of a precursor solution (viscous liquid).

(2) Application of Precursor Solution

The precursor solution was applied to the back surface of the substrate 1 by spin coating. Instead of spin coating, dip coating may be used.

As a mold 6, a silicone rubber mold having a plurality of recesses 6a in a shape of spherical surface having a pitch of 1.5 μm, a radius of curvature of 1.5 μm, and a depth of 0.25 μm, was used.

(3) Formation of Unevenness

The precursor solution on the back surface of the substrate 1 was pressed with the mold 6, and cured with UV light of wavelength 365 nm, followed by the removal of the mold 6.

As a result, unevenness having projections 5a and recesses 5b were formed on the back surface of the substrate 1. Flat portions of the unevenness were 20 nm to 100 nm thick. The inorganic material layer 50 had a refractive index of about 1.52.

In the light emitting device of the Inventive Example 7, some of the light that does not exit from the light emitting device structure 100 due to total reflection can be emitted outside through a diffraction effect. Consequently, the light extraction efficiency is improved by 70% as compared to that of the light emitting device in the Comparative Example.

### (Inventive Example 8)

(1) Preparation of Precursor Solution

In Inventive Example 8, instead of PhTMS in the Inventive Example 7, dimethyldiethoxysilane was used.

5.6 ml of MPTES, 5.8 ml of dimethyldiethoxysilane, 1.65 ml of hydrochloric acid with a concentration of 2 N, and 21 ml of ethanol were mixed, and left for 24 hours to allow hydrolysis and condensation polymerization of MPTES and dimethyldiethoxysilane to proceed. Then, 4 ml of the resultant solution was put in petri dish, and heated at 100° C. to remove ethanol by evaporation, resulting in about 1 g of a precursor solution (viscous liquid).

(2) Application of Precursor Solution

The precursor solution was applied to the back surface of the substrate 1 by spin coating. Instead of spin coating, dip coating may be used.

As a mold 6, similarly to the Inventive Example 7, a silicone rubber mold having a plurality of recesses 6a in a shape of spherical surface having a pitch of 1.5 μm, a radius of curvature of 1.5 μm, and a depth of 0.25 μm, was used.

(3) Formation of Unevenness

The precursor solution on the back surface of the substrate 1 was pressed with the mold 6, and heated at 140° C. for two hours to be cured, followed by the removal of the mold 6.

As a result, unevenness having projections 5a and recesses 5b were formed on the back surface of the substrate 1. Flat portions of the unevenness were 20-100 nm thick. The inorganic material layer 50 had a refractive index of about 1.45.

In the light emitting device of the Inventive Example 8, some of the light that does not exit from the light emitting device structure 100 due to total reflection can be emitted outside through a diffraction effect. Consequently, the light extraction efficiency is improved by about 50% as compared to that of the light emitting device in the Comparative Example.

### (Inventive Example 9)

In Inventive Example 9, instead of pentaethoxy tantalum in the Inventive Example 3, zirconium isopropoxide was used. As a resin, a silicone resin (refractive index: about 1.41) was used. Otherwise, the Inventive Example 9 was similar to the Inventive Example 3.

In the light emitting device of the Inventive Example 9, some of the light that does not exit from the light emitting device structure 100 due to total reflection can be emitted outside through a diffraction effect. Consequently, the light extraction efficiency is improved by about 80% as compared to that of the light emitting device in the Comparative Example.

### (Inventive Example 10)

In Inventive Example 10, instead of pentaethoxy tantalum in the Inventive Example 3, titanium isopropoxide was used. As a resin, PMMA (refractive index: about 1.5) was used. Otherwise, the Inventive Example 10 was similar to the Inventive Example 3.

In the light emitting device of the Inventive Example 10, some of the light that does not exit from the light emitting device structure 100 due to total reflection can be emitted outside through a diffraction effect. Consequently, the light extraction efficiency is improved by about 120% as compared to that of the light emitting device in the Comparative Example.

Although the present invention has been described and illustrated in detail, it is clearly understood that the same is by way of illustration and example only and is not to be taken by way of limitation, the spirit and scope of the present invention being limited only by the terms of the appended claims.

1. A light emitting device comprising:
a light emitting device structure including a light emitting layer and having a light extraction surface; and
a layer principally composed of an inorganic material different from a material constituting said light extraction surface, and formed on said light extraction surface of said light emitting device structure, wherein
said layer principally composed of the inorganic material is optically transparent to a luminescent wavelength of said light emitting device structure, and has unevenness on a surface opposite to said light extraction surface, and
said layer principally composed of the inorganic material includes a plurality of layers having different refractive indices, the refractive index of a layer on the side of said light extraction surface being greater than the refractive indice of another layer.

2. The light emitting device according to claim 1, wherein
said layer principally composed of the inorganic material has a refractive index greater than the refractive index of the material constituting said light extraction surface.

3. The light emitting device according to claim 1, wherein
said inorganic material includes a metal oxide.

4. The light emitting device according to claim 1, wherein
said layer principally composed of the inorganic material includes fine particles.

5. The light emitting device according to claim 4, wherein
said fine particles are composed of a metal oxide.

6. The light emitting device according to claim 1, wherein
said layer principally composed of the inorganic material includes an organometallic polymer having an -M-O-M-bond, where M is a metal and O is an oxygen atom.

7. The light emitting device according to claim 6, wherein
said organometallic polymer is synthesized from at least one kind of organometallic compounds having a hydrolytic organic group.

8. The light emitting device according to claim 7, wherein
said organometallic compound is a metal alkoxide.

9. The light emitting device according to claim 7, wherein
said organometallic compound has functional groups directly or indirectly bonding to a metal atom, at least one of which can be cured by being subjected to externally supplied energy to be bridged.

10. The light emitting device according to claim 9, wherein
said externally supplied energy is one of or both of energy by heating and energy by irradiation of light.

11. The light emitting device according to claim 7, wherein
said organometallic compound includes at least one or more compounds selected from the group consisting of 3-methacryloxypropyltriethoxysilane (MPTES), 3-methacryloxypropyltrimethoxysilane (MPTMS), and 3-acryloxypropyltrimethoxysilane.

12. The light emitting device according to claim 1, wherein
said layer principally composed of the inorganic material has a structure in which the inorganic material is dispersed in an organic polymer.

13. A light emitting device comprising:
a light emitting device structure including a light emitting layer and having a light extraction surface; and
a layer principally composed of an inorganic material different from a material constituting said light extraction surface, and formed on said light extraction surface of said light emitting device structure, wherein
said layer principally composed of the inorganic material is optically transparent to a luminescent wavelength of said light emitting device structure, and has unevenness on a surface opposite to said light extraction surface,
said light emitting device structure constitutes a light emitting device chip, and
said layer principally composed of the inorganic material is formed on said light extraction surface of said light emitting device chip except its outer peripheral region or is smaller in thickness on the outer peripheral region of said light extraction surface of said light emitting device chip than on its remaining region.

14. The light emitting device according to claim 13, wherein
said layer principally composed of the inorganic material has a refractive index greater than the refractive index of the material constituting said light extraction surface.

15. The light emitting device according to claim 13, wherein
said inorganic material includes a metal oxide.

16. The light emitting device according to claim 13, wherein
said layer principally composed of the inorganic material includes fine particles.

17. The light emitting device according to claim 16, wherein
said fine particles are composed of a metal oxide.

18. The light emitting device according to claim 13, wherein
said layer principally composed of the inorganic material includes an organometallic polymer having an -M-O-M-bond, where M is a metal and O is an oxygen atom.

19. The light emitting device according to claim 18, wherein
said organometallic polymer is synthesized from at least one kind of organometallic compounds having a hydrolytic organic group.

20. The light emitting device according to claim 19, wherein
said organometallic compound is a metal alkoxide.

21. The light emitting device according to claim 19, wherein
said organometallic compound has functional groups directly or indirectly bonding to a metal atom, at least one of which can be cured by being subjected to externally supplied energy to be bridged.

22. The light emitting device according to claim 21, wherein
said externally supplied energy is one of or both of energy by heating and energy by irradiation of light.

23. The light emitting device according to claim 19, wherein
said organometallic compound includes at least one or more compounds selected from the group consisting of 3-methacryloxypropyltriethoxysilane (MPTES), 3-methacryloxypropyltrimethoxysilane (MPTMS), and 3-acryloxypropyltrimethoxysilane.

24. A method of fabricating a light emitting device comprising the steps of:
forming a light emitting device structure including a light emitting layer and having a light extraction surface; and
forming on said light extraction surface of said light emitting device structure a layer principally composed of an inorganic material different from a material constituting said light extraction surface that is optically transparent to a luminescent wavelength of said light emitting device structure and having unevenness on the surface opposite to said light extraction surface, wherein
said step of forming said layer principally composed of the inorganic material includes the step of forming said unevenness by embossing.

25. The method of fabricating a light emitting device according to claim 24, wherein
said step of forming said layer principally composed of the inorganic material includes the step of forming said layer principally composed of the inorganic material layer by applying a solution on said light extraction surface of said light emitting device structure.

26. The method of fabricating a light emitting device according to claim 25, wherein
said solution is a solution in which fine particles are dispersed.

27. The method of fabricating a light emitting device according to claim 25, wherein
said solution includes an organic polymer in which fine particles are dispersed.

28. The method of fabricating a light emitting device according to claim 27, wherein
said fine particles are composed of a metal oxide.

29. The method of fabricating a light emitting device according to claim 27, wherein
said solution includes an organometallic polymer having an -M-O-M-bond, where M is a metal and O is an oxygen atom.

30. The method of fabricating a light emitting device according to claim 29, wherein
said organometallic polymer is synthesized from at least one kind of organometallic compounds having a hydrolytic organic group.

31. The method of fabricating a light emitting device according to claim 30, wherein
said organometallic compound is a metal alkoxide.

32. The method of fabricating a light emitting device according 2 to claim 30, wherein
said organometallic compound has functional groups directly or indirectly bonding to a metal atom, at least one of which can be cured by being subjected to externally supplied energy to be bridged.

33. The method of fabricating a light emitting device according to claim 32, wherein
said externally supplied energy is one of or both of energy by heating and energy by irradiation of light.

34. The method of fabricating a light emitting device according to claim 30, wherein
said organometallic compound includes at least one or more compounds selected from the group consisting of 3-methacryloxypropyltriethoxysilane (MPTES), 3-methacryloxypropyltrimethoxysilane (MPTMS), and 3-acryloxypropyltrimethoxysilane.
